(19) United States
(12) Patent Application Publication
(10) Pub. No.: US 2011/0147442 A1
(43) Pub. Date: Jun. 23, 2011

(54) PACKAGE FOR FOOD PRODCUTS

(76) Inventor: Katherine Ann Griffin, Cranbury, NJ (US)

(21) Appl. No.: 12/643,293

(22) Filed: Dec. 21, 2009

(51) Int. Cl. B65D 5/56; B65D 43/16; B31B 7/00

(52) U.S. Cl. 229/117.27; 220/810; 493/95

(57) ABSTRACT

This invention provides a package for dry food products. Generally, this invention comprises an outer rectangular prismatic carton having a chamfered panel extending from the top panel to a side panel. There is an inner liner inside the carton, and a hinged top lid attached to the chamfered panel. The inner liner is attached to the carton or the lid. The lid is attached to the carton so it will not be lost and can be easily closed. Unlike a conventional cereal box top, it will be obvious if the flip top remains open. This invention will reduce the amount of spillage and stale cereal.

### TECHNICAL FIELD

This invention relates to packages for food products, and in particular to packages for cereal.

Cereal is most often packaged in a bag inside a rectangular paperboard folded carton or box with reclosable flaps on the top to provide access to the contents. An internal liner or bag is provided to protect the contents and preserve freshness. The carton, which protects that product from being crushed, is convenient to store on a shelf and provides substantial display surfaces for product information and advertising. However, these packages suffer from a number of inconveniences. First, it can be difficult to initially open the internal liner or bag. Second, once opened it is difficult to reclose the package. The internal liner or bag is simply “rolled up” and readily unrolls, and the flaps on the box top often come undone.

If the bag is not properly closed it may not be obvious. Thus, the product can become stale, and there is a risk of spillage if the package is knocked over or tilted. Third, it can be difficult to accurately pour the product from the container without spillage. The fact that children with developing motor skills are often involved with pouring cereal increases the chance that cereal will be spilled and liners not properly closed. In addition, the many competing brands on store shelves typically use cartons of the same shape; it is difficult to make any brand stand out from the rest given the similarity of carton shapes.

To address the inconvenience issues, several types of packages were designed to preserve freshness and reduce the risk of spillage. U.S. Pat. No. 7,097,092 to Marrale (2006) discloses a reclosable bag within a box with perforated corners that enable the corner of the box to be removed in order to access the bag. Permanently ripping off a portion of a cereal box to access the bag is cumbersome and is unlikely to gain favor from a consumer population that is not accustomed to damaging new food packages. Furthermore, like the traditional bag, it may not be obvious that the reclosable bag is not firmly closed.

U.S. Pat. No. 6,318,626 to St. Pierre and Thiemann (2001) discloses a type of reclosable top that includes flaps of the outer carton attached to the inner liner. This container, however, requires three flaps to be opened to pour and closed to preserve freshness. The unique nature of the opening increases the likelihood that it will not be closed properly to preserve freshness. Furthermore, many consumers will not notice the nature of the package since its shape is not unique.

The pour spout described in U.S. Pat. No. 3,981,430 to Keim (1976) does not provide for a method of sealing off the carton liner, it simply seals the carton. Likewise, the U.S. patent application publication 2006/0054675 provided to Bennett (2006) provides for a pouring spout but not a method for sealing the liner, and the need for applying a certain amount of hand pressure to properly operate the spout makes it difficult for children to use.

### SUMMARY

Aspects of the invention are embodied in a packages and methods in which a plurality of walls connect a top portion and a bottom portion defining an interior space capable of holding dry goods. The top portion has an opening so that dry goods contained within the interior space can be dispensed. A lid is coupled to the opening by a hinged portion that forms a substantially airtight seal of the interior space when closed. The top portion is formed to provide space for the lid to be positioned on the opening to facilitate stacking of the food product package. The food product package preferably has a liner within the interior space. The liner said liner forming a seal with said lid.

### BRIEF DESCRIPTION OF THE DRAWINGS

FIG. 1 is a perspective view of an unopened package for food products embodying this invention.

FIG. 2 is a side view of a package with the top open.

FIG. 3 is a cross section cut vertically through the center of the package and parallel to front panel 16, this is Section 100 on FIG. 1.

FIG. 4 shows an enlargement of an embodiment of a flip top type cap

FIG. 5 shows an enlargement of an alternative embodiment of a flip top type cap

FIG. 6 shows an enlargement of an embodiment of a chamfered wall of the package.

FIG. 7 shows an enlargement of an alternative embodiment of a chamfered wall of the package.

FIG. 8 shows an example method of constructing the package.

### DETAILED DESCRIPTION OF ILLUSTRATIVE EMBODIMENTS

Certain specific details are set forth in the following description and figures to provide a thorough understanding of various embodiments of the inventions. Certain well-known details often associated with packaging are not described in the following disclosure for the sake of clarity. Furthermore, those of ordinary skill in the relevant art will understand that they can practice other embodiments of the disclosed subject matter without one or more of the details described below. While methods are described with reference to steps and sequences in the following disclosure, the description as such is for providing a clear implementation of embodiments of the disclosed subject matter, and the steps and sequences of steps should not be taken as required to practice the invention.

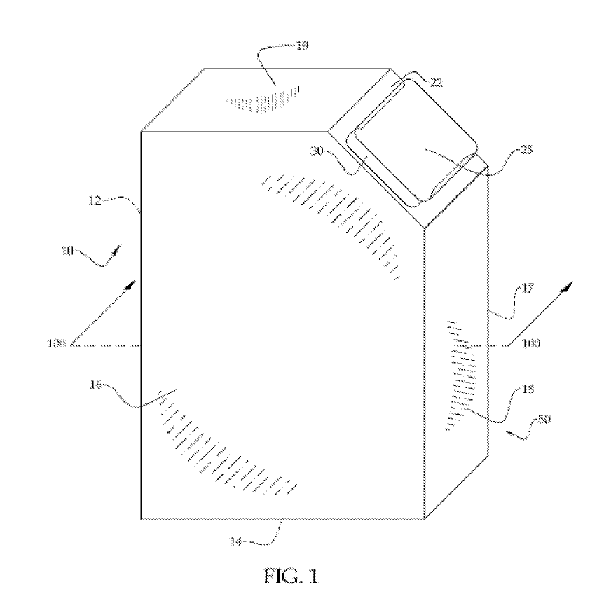

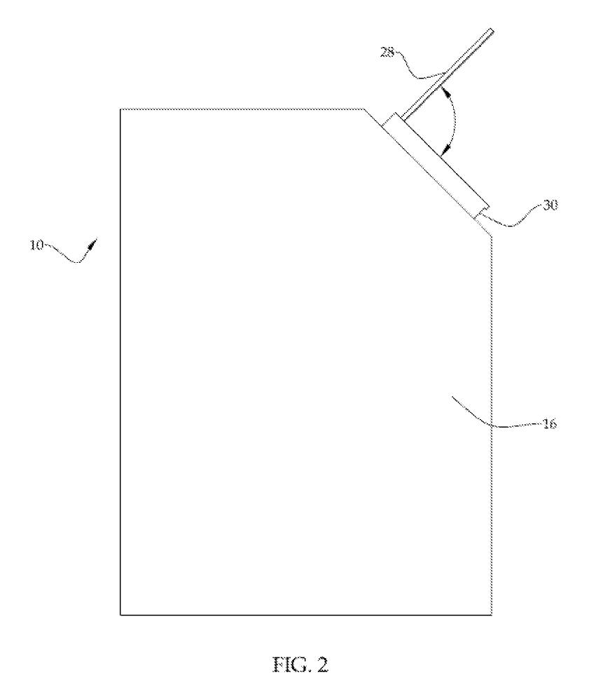

FIGS. 1 through 3 illustrate an example of package 10 comprising outer carton 50 and flexible inner liner or bag 34. Generally, and as illustrated in FIG. 3, outer carton 50 has a semi-rigid construction, inner liner 34 is positioned inside the outer carton, and a supply of a food product 20 is contained within the liner. FIG. 2 is provided to illustrate one embodiment of lid that has a base 30 and a flip top cap 28 shown in the open position.

With the embodiment of package 10 illustrated in FIGS. 1 through 3, outer carton 50 has a generally rectangular prismatic shape, and includes front panel 16, back panel 17, side panels 12 and 18. The front, back, and side panels 16, 17, 12, and 18, respectively, form the walls of the food product package. A substantially planar bottom panel 14, top panel 19; and chamfered panel 22 together with the walls define an interior space in the package. The chamfered panel is disposed at an angle relative to top panel 19. Also, with this embodiment of package 10, inner liner 34 preferably has a generally rectangular configuration with a chamfered corner to match the container. Of course, the liner may also be formed out of a suitably flexible material that may generally conform to the shape of the interior space through the application of air pressure, for example.

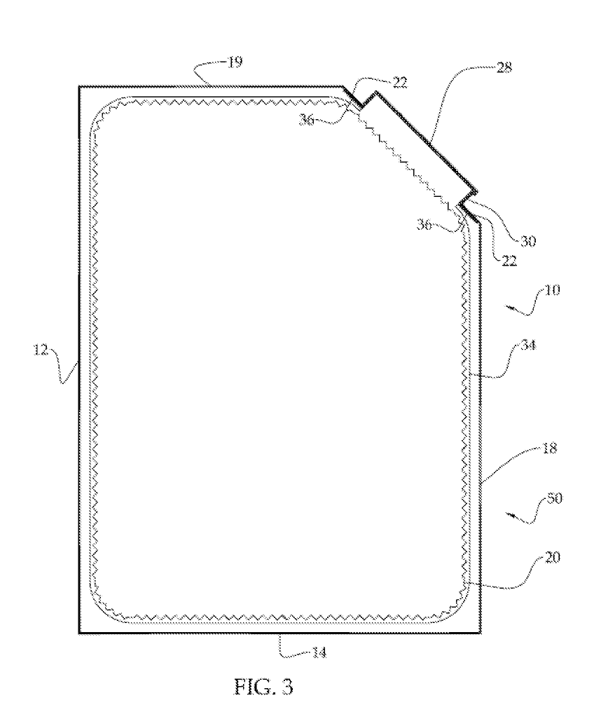

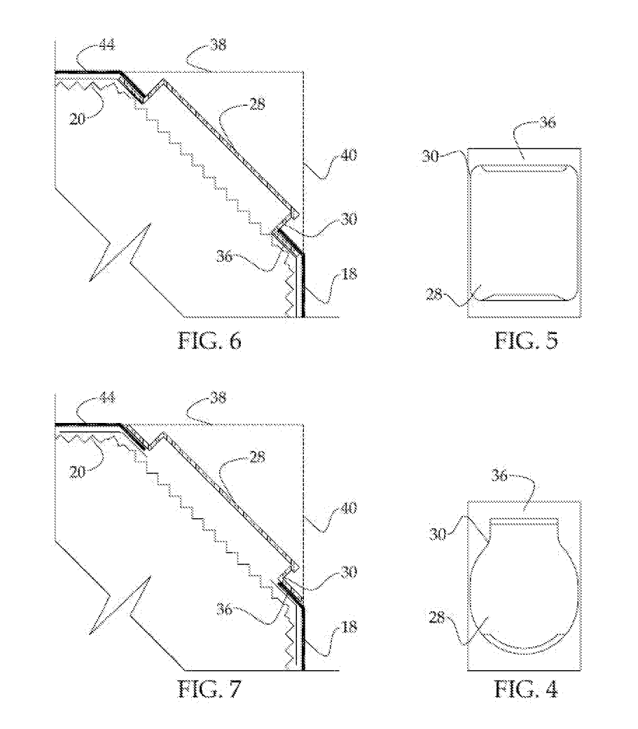

Two embodiments of the shape of the flip top cap 28 and the cap base 30 are shown in FIGS. 4 and 5. In accordance with this invention, a flip top cap 28 is attached to a cap base 30 which is attached to a cap flange 36.

One embodiment of the invention is illustrated in the exploded view of the flip top cap 28 in FIG. 6. The cap, which extends out of the package on the chamfered panel, does not extend beyond the two planes, 38 and 40, formed by the top panel 19 and side panel 18 of the package. This embodiment allows packages to be stacked for shipment without the flip top cap 28 protruding into adjacent packages.

The cap flange 36 may be designed to attach to the liner 34 and chamfered panel 22 in any one of a number of ways. For instance, with reference to FIG. 6, the liner 34 may be bonded to the underside of the cap flange 36, and the cap flange 36 may be bonded to the underside of the chamfered panel 22. Alternatively, as illustrated in FIG. 7, the liner 34 may be bonded to the underside of the chamfered panel 22, and the cap flange may be bonded to the top side of the chamfered panel 22.

The flip cap may be designed in any one of a number of ways. For instance, cap base 30 and flip top 28 are shown in FIGS. 4 and 5 in both rounded and rectangular shapes, other alternative shapes will also work. The flip cap must be made of a firm material, plastic or firm paperboard are two options. The flip cap is movable with respect to the base portion and should be hinged or bendable at the upper end. Preferably, the cap is able to remain in the open position to allow food product to flow smoothly out of the package opening without obstruction from the flip cap itself. An attached flip cap will not be misplaced or lost which makes it a preferable embodiment to, for example, a screw-off top.

Carton 50 and liner 34 may be made of any suitable materials. For example, the carton may be made from a natural carton board provided with an embossed finish. This carton offers a unique look, feel and shape given the chamfered panel.

Many types of food products can be held in package 10. As indicated above, package 10 is very well suited for use with cereal products, but other products such as pretzel nuggets, nuts, candies, pasta and certain fruits and vegetables could be held and sold in containers embodying the present invention.

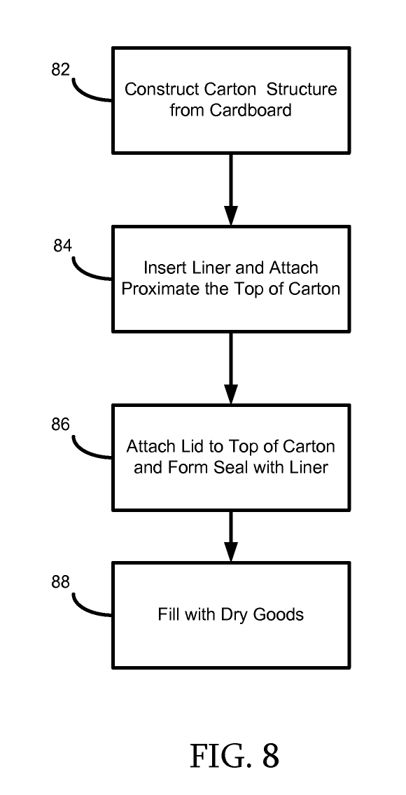

FIG. 8 illustrates an example of a method of constructing the package 10. Of course, this is just a high level description. Alternative methods can be used to construct the package that conform to a particular packaging need. For example, it may be more convenient to insert the food product into the liner prior to attaching the liner within the carton. At first step 82, the basic carton 50 is at least partially constructed. This can be done by techniques that are well known to the those of skill in the art but in general will comprises cutting a shape out of cardboard and folding the shape as appropriate and using adhesive material to form a closed structure. Of course, various printing may be applied to one or more sides of the cardboard. After the carton 50 is at least partially constructed, at step 84, the liner may be inserted into the carton and, preferably adhesively attached proximate the top of the carton. The lid may then be attached to the carton and the liner at step 86. Alternatively the lid may be attached prior to attachment of the liner. The package may then be filled with dry goods through the dispenser opening of the package as is demonstrated at step 88.

While it is apparent that the invention herein disclosed is well calculated to fulfill the objectives stated above, it will be appreciated that numerous modifications and embodiments may be devised by those skilled in the art, and it is intended that the appended claims cover all such modifications and embodiments as fall within the true spirit and scope of the present invention.

What is claimed:

1. A food product package, comprising:
a substantially planar bottom portion;
a plurality of walls connecting a top portion and the bottom portion defining an interior space capable of holding dry goods;
said top portion having an opening therein to dispense dry goods contained within the interior space; and
a lid coupled to said opening by a hinged portion and forming a substantially airtight seal of the interior space when closed wherein said top portion is formed to provide space for the lid to be position on the opening to facilitate stacking of the food product package.

2. The food product package as recited in claim 1 wherein said walls comprise cardboard.

3. The food product package as recited in claim 1 comprising a liner within said interior space, said liner forming a seal with said lid.

4. The food product package as recited in claim 1 wherein the interior space is substantially rectangular in cross-section.

5. The food product package as recited in claim 1 wherein the lid is positioned proximate one corner of the product package and wherein the lid is disposed at an angle relative to the top portion.

6. The food product package as recited in claim 3 wherein the lid comprises a fixed portion and a movable portion, wherein the liner is attached to the fixed portion and wherein the fixed portion and the movable portion are coupled by a hinge.

7. The food product package as recited in claim 6, wherein the lid is formed of molded plastic.

8. The food product package as recited in claim 7 wherein the liner is attached to the lid with an adhesive.

9. A food product package, comprising:
a container comprising:
a substantially planer bottom portion;
a plurality of walls connecting a substantially planar top portion and the bottom portion defining an interior space, the container having a chamfered corner, said top portion having an opening in the chamfered corner to dispense dry goods contained within the interior space;
a lid comprising a fixed portion and a movable portion, wherein the fixed portion and the movable portion are coupled by a flexible hinge, said lid attached to the chamfer corner;
a liner adhesively attached to the fixed portion of the lid and disposed within said interior space; said lid and liner forming a substantially airtight seal of the interior space when said movable portion of said lid is sealed against the fixed portion of the lid; and
a food product disposed within said interior space.

10. The food product package as recited in claim 9 wherein the food product comprises cereal.

11. The food product package as recited in claim 9 wherein the lid comprises a single piece of molded plastic.

12. The food product package as recited in claim 9 wherein the liner comprises a flexible material.

13. The food product package as recited in claim 9 wherein the plurality of walls comprise cardboard.

14. The food product package as recited in claim 9wherein the interior space is substantially rectangular in cross-section.

15. Method for assembling a food product container
attaching a liner within a cardboard box
inserting a food material within the liner
attaching a top lid with an opening in one end for dispensing the food material, wherein said lid comprise a fixed portion attached to said cardboard box and a movable portion attached to the fixed portion and forming a substantially airtight seal in the closed position and having an open position for dispensing food product; and,
adhesively attaching the liner to the fixed portion of the lid.

16. The method as recited in claim 15 comprising, forming an angle in one corner of said cardboard box wherein the step of attaching said lid comprises attaching said lid proximate the angled corner of said cardboard box.

17. The method as recited in claim 15 wherein said lid is adhesively attached to said cardboard box.

18. The method as recited in claim 15 wherein said food material comprises cereal.

19. The method as recited in claim 15 comprising attaching an ornamental feature proximate said lid.

20. The method as recited in claim 15 comprising molding said lid from a plastic material.
